(19) United States
(12) Patent Application Publication
(10) Pub. No.: US 2012/0150959 A1
(43) Pub. Date: Jun. 14, 2012

(54) SPAM COUNTERING METHOD AND APPARATUS

(75) Inventors: SO YUNG PARK, Daejeon (KR); Sung Hei KIM, Daejeon (KR); Shin Gak KANG, Daejeon (KR); Wook HYUN, Daejeon (KR)

(73) Assignee: ELECTRONICS AND TELECOMMUNICATIONS RESEARCH INSTITUTE, Daejeon (KR)

(21) Appl. No.: 13/299,065

(22) Filed: Nov. 17, 2011

(30) Foreign Application Priority Data
Dec. 14, 2010 (KR) 10-2010-0127374

(51) Int. Cl. G06F 15/16

(52) U.S. Cl. 709/204

(57) ABSTRACT

In an apparatus for countering IP multimedia spam, a transmitter receives an IP application, and blocks the IP application when the IP application is determined as spam. A spam identifier receives the IP application from the transmitter, and analyzes at least one of a content of the IP application and a protocol of the IP application. A controller controls the spam identifier based on a setting for anti-spam, and determines whether the IP application is spam or not based on the analyzing result for the IP application of the spam identifier and transmits the determining result to the transmitter.

### CROSS-REFERENCE TO RELATED APPLICATION

This application claims priority to and the benefit of Korean Patent Application No. 10-2010-0127374 filed in the Korean Intellectual Property Office on Dec. 14, 2010, the entire contents of which are incorporated herein by reference.

### BACKGROUND

(a) Field

The present invention relates to a spam countering method and apparatus, and more particularly, to a method and apparatus for countering internet protocol (IP) multimedia spam.

(b) Description of the Related Art

In the past years, massive amounts of email spam and short message service (SMS) spam in mobile phones have been appearing, causing damage to service providers and service users. Accordingly, various techniques for countering email and SMS spam have been developed.

Recently, IP multimedia spam that may appear on IP multimedia applications such as internet telephony and instant messaging service (IMS) have been emerging as a new threat. Hence, there is a demand for a technique for countering the spam. However, there are limitations in applying the conventional techniques, which were developed to counter email spam and SMS spam, to IP multimedia spam.

### SUMMARY

Embodiments of the present invention provide a method and apparatus for efficiently countering IP multimedia spam.

An embodiment of the present invention provides an apparatus for countering IP multimedia spam. The apparatus includes a transmitter, a spam identifier, and a controller. The transmitter receives an IP application, and blocks the IP application when the IP application is determined as spam. The spam identifier receives the IP application from the transmitter, and analyzes at least one of a content of the IP application and a protocol of the IP application. The controller controls the spam identifier based on settings for anti-spam, and determines whether the IP application is spam or not based on the analyzing result for the IP application of the spam identifier and transmits the determining result to the transmitter.

The spam identifier may include a content analyzer configured to analyze the content of the IP application including at least one of a text, a sound, and an image.

The spam identifier may include a protocol analyzer configured to analyze the protocol of the IP application, and the protocol analyzer may include a source analyzer configured to analyze source information of the IP application.

The source information may include at least one of an IP address of a sender sending the IP application, a domain name of the sender, and an account name of the sender.

The spam identifier may include a protocol analyzer configured to analyze the protocol of the IP application, and the protocol analyzer may include a characteristic analyzer configured to analyze characteristics of the IP application.

The characteristic analyzer may analyze the characteristics of the IP application to check at least one of a scale of the IP application, interoperability of the IP application, and a label of the IP application.

The controller may have setting information for controlling the spam identifier, and determine whether the IP application is spam or not based on an anti-spam policy.

Another embodiment of the present invention provides a method of countering IP multimedia spam in a spam countering apparatus. The method includes receiving an IP application, analyzing at least one of a content of the IP application and a protocol of the IP application based on settings for anti-spam, determining whether the IP application is spam or not based on the analyzing result for the IP application and an anti-spam policy; and determining whether to block or pass the IP application based on the determining result about whether the IP application is spam or not.

Analyzing the at least one may include analyzing at least one of a text, a sound, and an image which are included in the content of the IP application.

Analyzing the at least one may include analyzing source information in the protocol of the IP application.

The source information may include at least one of an IP address of a sender sending the IP application, a domain name of the sender, and an account name of the sender.

Analyzing the at least one may include analyzing characteristics of the IP application based on the protocol of the IP application.

Analyzing the at least one may further include checking at least one of a scale of the IP application, an interoperability of the IP application, and a label of the IP application.

Yet another embodiment of the present invention provides a proxy server configured to be connected to an application server and counter IP multimedia spam. The proxy server includes a transmitter and a spam identifier. The transmitter receives an IP application, and blocks the IP application when the IP application is determined as spam. The spam identifier receives the IP application from the transmitter, analyzes a protocol of the IP application based on settings for anti-spam provided by the application server, and provides the analyzing result for the protocol of the IP application to the application server so that the application server determines whether the IP application is spam or not. The transmitter receives, from the application server, information about whether the IP application is spam or not.

### BRIEF DESCRIPTION OF THE DRAWINGS

FIG. 1 is a schematic block diagram of an apparatus for countering IP multimedia spam according to one embodiment of the present invention.

FIG. 2 is a schematic flowchart of a method for countering IP multimedia spam according to one embodiment of the present invention.

FIGS. 3 to 5 are views showing an example of implementing an IP multimedia spam countering apparatus according to one embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Now, an apparatus and method for countering IP multimedia spam according to one embodiment of the present invention will be described in details with reference to the accompanying drawings.

In an embodiment of the present invention, IP multimedia spam means various types of spam that may appear on IP multimedia applications such as internet telephony and messaging service.

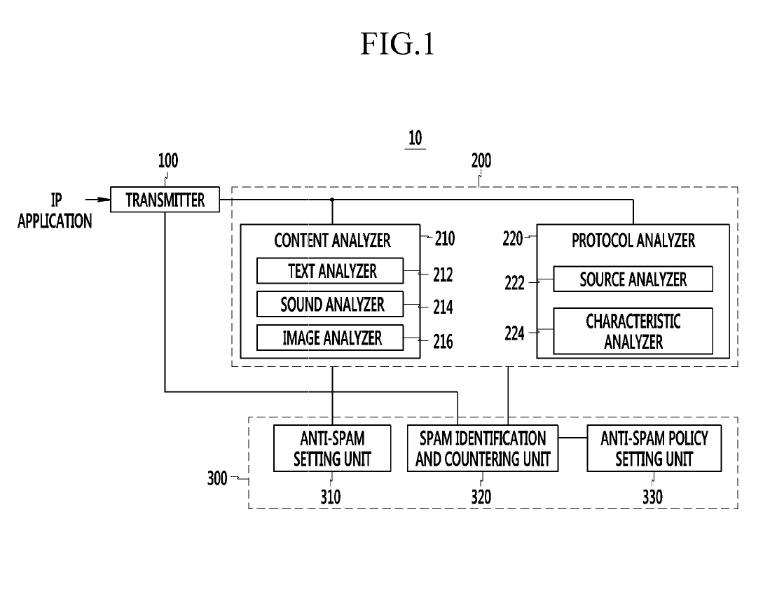

FIG. 1 is a schematic block diagram of an IP multimedia spam countering apparatus according to an embodiment of the present invention.

Referring to FIG. 1, the IP multimedia spam countering apparatus 10 includes a transmitter 100, a spam identifier 200, and a controller 300.

The transmitter 100 receives an IP application from the outside and transmits it to the spam identifier 200.

The spam identifier 200 analyzes the IP application in order to determine whether the IP application received from the transmitter 200 is spam or not. The spam identifier 200 includes a content analyzer 210 and a protocol analyzer 220.

The content analyzer 210 analyzes the content, i.e., the payload, of the IP application to identify spam, and includes a text analyzer 212, a sound analyzer 214, and an image analyzer 216. The text analyzer 212 analyzes texts in the content of the IP application, the sound analyzer 214 analyzes sounds in the content of the IP application, and the image analyzer 216 analyzes images in the content of the IP application. That is, the content analyzer 210 analyzes at least one of the texts, the sounds, and the images included in the content of the IP application to determine whether the content of the IP application is spam or not.

The protocol analyzer 220 analyzes the protocol part of the IP application to identify spam, and includes a sound analyzer 222 and a characteristic analyzer 224. The source analyzer 222 analyzes source information of the IP application such as the sender's IP address, the sender's domain name, and/or the sender's account name, in order to determine if the IP application has been transmitted by a sender registered as sending spam. The characteristic analyzer 224 analyzes unique characteristics of the IP application to identify spam. For example, the characteristic analyzer 224 may determine whether the IP application has any characteristics of spam by analyzing the scale of the IP application, or by checking the interoperability of the IP application or the label of the IP application.

The controller 300 controls the transmitter 100 and the spam identifier 200, and receives setting information for controlling the transmitter 100 and the spam identifier 200. The controller 300 includes an anti-spam setting unit 310, a spam identification and blocking unit 320, and an anti-spam policy setting unit 330.

The anti-spam setting unit 310 has setting information about what type of analysis is to be performed on the received IP application, and controls the spam identifier 200 based on the setting information. The spam identification and blocking unit 320 receives an analysis result of the IP application from the spam identifier 200, and determines whether the analyzed IP application is spam or not under the support of the anti-spam policy setting unit 330. The anti-spam policy setting unit 330 provides the spam identification and blocking unit 320 with an anti-spam policy required for determining whether the IP application is spam or not.

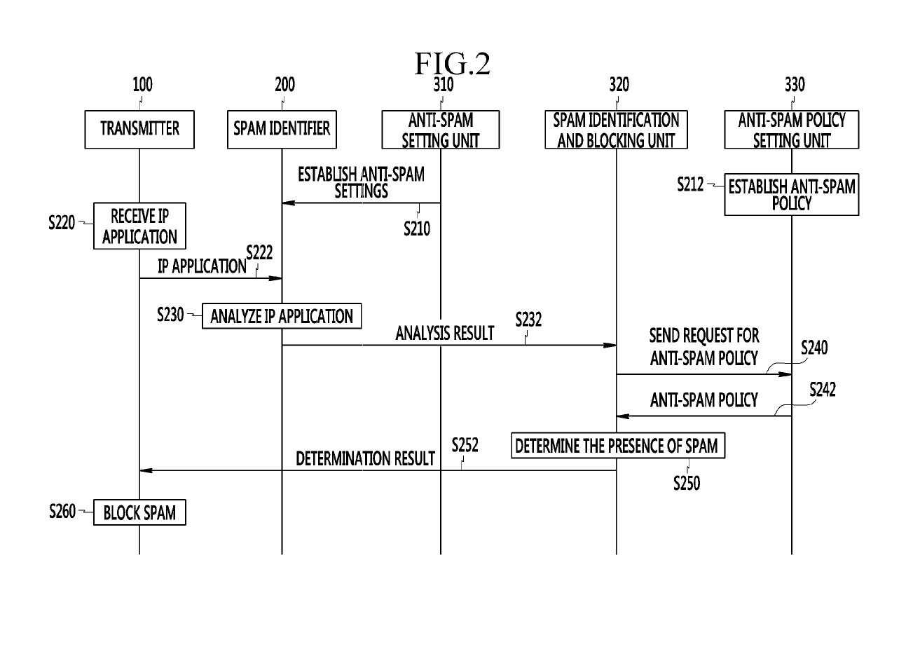

FIG. 2 is a schematic flowchart of a method for countering IP multimedia spam according to an embodiment of the present invention.

Referring to FIG. 2, the anti-spam setting unit 310 and the anti-spam policy setting unit 320 configures basic settings for anti-spam (S210, S212). The anti-spam setting unit 310 transmits information about anti-spam settings received from the outside to the spam identifier 200 (S210). Moreover, the anti-spam policy setting unit 330 receives settings about an anti-spam policy from the outside (S212).

With these basic settings established, when the transmitter 100 receives an IP application (S220), it transmits the IP application to the spam identifier 200 (S222). The spam identifier 200 analyzes the IP application based on the anti-spam settings (S230), and transmits the analysis result to the spam identification and blocking unit 320 (S232). To determine whether the IP application is spam or not based on the analysis result, the spam identification and blocking unit 320 sends the anti-spam policy setting unit 330 a request for information about the anti-spam policy (S240), and receives the corresponding information from the anti-spam policy setting unit 330 (S242). The spam identification and blocking unit 320 determines whether the IP application is spam or not based on the information about the anti-spam policy (S250), and transmits a determination result to the transmitter 100 (S252).

The transmitter 100 blocks the IP application determined as spam by the spam identification and blocking unit 320 (S260), and transmits the IP application which has not been determined as spam so that a normal service can be performed.

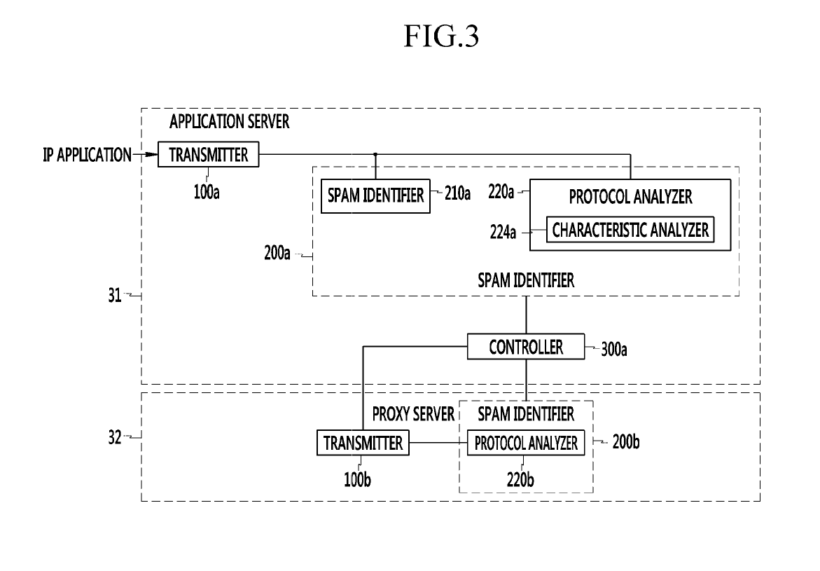

As described with reference to FIG. 1, each of the transmitter 100, spam identifier 200, and controller 300 of the IP multimedia spam countering apparatus 10 may include at least one module and/or function. Individual function and/or module can be logically divided, and can be physically separated or combined. Moreover, one module and/or function may be implemented in entities on a network. These embodiments will be described with reference to FIGS. 3 to 5.

FIGS. 3 to 5 are views showing an example of implementing an IP multimedia spam countering apparatus according to one embodiment of the present invention.

Referring to FIG. 3, an IP multimedia spam countering apparatus is implemented in an application server 31 and a proxy server 32.

A transmitter 100a, some functions of a spam identifier 200a, and a controller 300a are implemented in the application server 31, and a transmitter 100b and some functions of a spam identifier 200b are implemented in the proxy server 32. For example, a content analyzer 210a of the spam identifier 200a and a characteristic analyzer 224a of a protocol analyzer 220a may be implemented in the application server 31, and a protocol analyzer 220b of the spam identifier 200b may be implemented in the proxy server 32.

When no controller is implemented in the proxy server 32, the spam identifier 200b of the proxy server 32 analyzes the protocol of an IP application based on the anti-spam settings provided by a controller 300a of the application server 31, and transmits the analysis result to the controller 300a of the application server 31. Then, the controller 300a of the application server 31 determines whether the IP application is spam or not based on the analysis result of the proxy server 32 and/or the analysis result of the application server 31, and transmits the result to the transmitter 100b of the proxy server 32.

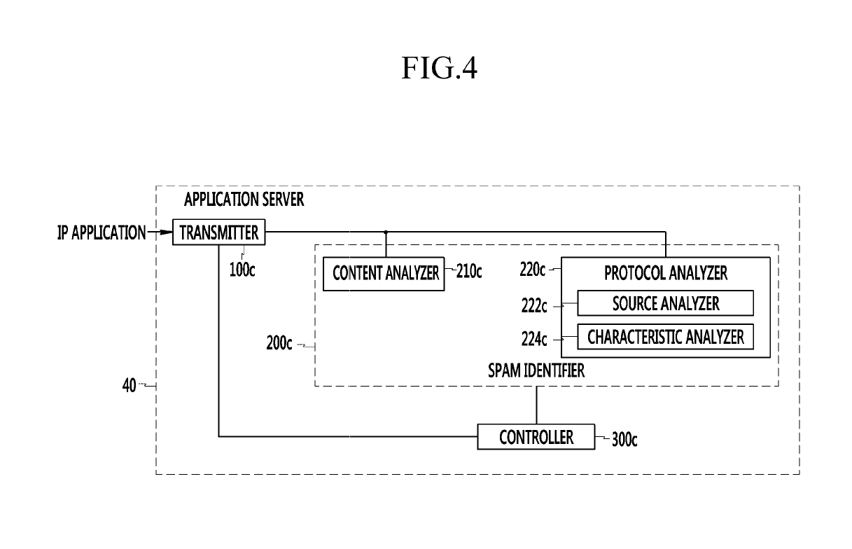

Referring to FIG. 4, an IP multimedia spam countering apparatus is implemented in an application server 40.

A transmitter 100c, a spam identifier 200c, and a controller 300c is implemented in the application server 40. For example, a content analyzer 210c of the spam identifier 200c and a source analyzer 222c and characteristic analyzer 224c of the protocol analyzer 220c may be all implemented in the application server 40.

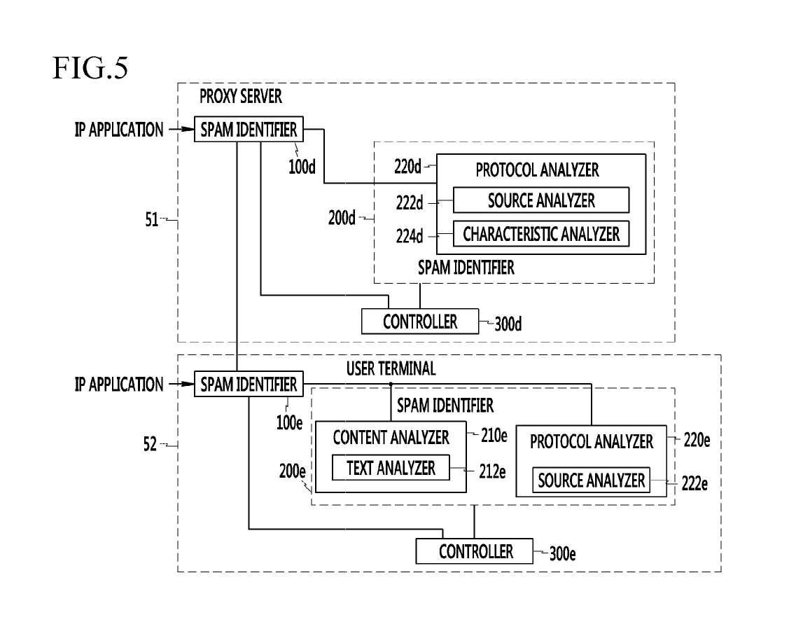

Referring to FIG. 5, an IP multimedia spam countering apparatus is implemented in a proxy server 51 and a user terminal 52.

A transmitter 100d, some functions of a spam identifier 200d, and a controller 300d are implemented in the proxy server 51, and a transmitter 100e, some functions of a spam identifier 200e, and a controller 300e are implemented in the user terminal 52. For example, a protocol analyzer 200d, that is, a source analyzer 222d and a characteristic analyzer 224d, of the spam identifier 200d may be implemented in the proxy server 51, and a text analyzer 212e of a content analyzer 210e and a source analyzer 222e of a protocol analyzer 220e in the spam identifier 200e may be implemented in the user terminal 52.

As described above, according to an embodiment of the present invention, a module and/or function for countering IP multimedia spam can be implemented in appropriate entities on a network that provides IP application service, thus effectively identifying and countering IP multimedia spam that may appear in various IP application services, such as internet telephony and messaging service.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for countering internet protocol (IP) multimedia spam, the apparatus comprising:
a transmitter configured to receive an IP application, and block the IP application when the IP application is determined as spam;
a spam identifier configured to receive the IP application from the transmitter, and analyze at least one of a content of the IP application and a protocol of the IP application; and
a controller configured to control the spam identifier based on settings for anti-spam, determine whether the IP application is spam or not based on the analyzing result for the IP application of the spam identifier, and transmit the determining result to the transmitter.

2. The apparatus of claim 1, wherein the spam identifier comprises a content analyzer configured to analyze the content of the IP application including at least one of a text, a sound, and an image.

3. The apparatus of claim 1, wherein the spam identifier comprises a protocol analyzer configured analyze the protocol of the IP application, and
the protocol analyzer comprises a source analyzer configured to analyze source information of the IP application.

4. The apparatus of claim 3, wherein the source information comprises at least one of an IP address of a sender sending the IP application, a domain name of the sender, and an account name of the sender.

5. The apparatus of claim 1, wherein the spam identifier comprises a protocol analyzer configured to analyze the protocol of the IP application, and
the protocol analyzer comprises a characteristic analyzer configured to analyze characteristics of the IP application.

6. The apparatus of claim 5, wherein the characteristic analyzer analyzes the characteristics of the IP application to check at least one of a scale of the IP application, interoperability of the IP application, and a label of the IP application.

7. The apparatus of claim 1, wherein the controller has setting information for controlling the spam identifier, and determines whether the IP application is spam or not based on an anti-spam policy.

8. A method of countering internet protocol (IP) spam in a spam countering apparatus, the method comprising:
receiving an IP application;
analyzing at least one of a content of the IP application and a protocol of the IP application based on settings for anti-spam;
determining whether the IP application is spam or not based on the analysis result for the IP application and an anti-spam policy; and
determining whether to block or pass the IP application based on the determining result about whether the IP application is spam or not.

9. The method of claim 8, wherein analyzing the at least one comprises analyzing at least one of a text, a sound, and an image which are included in the content of the IP application.

10. The method of claim 8, wherein analyzing the at least one comprises analyzing source information in the protocol of the IP application.

11. The method of claim 10, wherein the source information comprises at least one of an IP address of a sender sending the IP application, a domain name of the sender, and an account name of the sender.

12. The method of claim 8, wherein analyzing the at least one comprises analyzing characteristics of the IP application based on the protocol of the IP application.

13. The method of claim 12, wherein analyzing the at least one further comprises checking at least one of a scale of the IP application, interoperability of the IP application, and a label of the IP application.

14. A proxy server configured to be connected to an application server and counter IP multimedia spam, the proxy server comprising:
a transmitter configured to receive an IP application, and block the IP application when the IP application is determined as spam; and
a spam identifier configured to receive the IP application from the transmitter, analyze a protocol of the IP application based on a setting for anti-spam provided by the application server, and provide the analyzing result for the protocol of the IP application to the application server so that the application server determines whether the IP application is spam or not,
wherein transmitter receives, from the application server, information about whether the IP application is spam or not.

15. The proxy server of claim 14, wherein the spam identifier comprises a source analyzer configured to analyze source information of the IP application.

16. The proxy server of claim 14, wherein the spam identifier comprises a characteristic analyzer configured to analyze characteristics of the IP application.

17. The proxy server of claim 16, wherein the characteristic analyzer checks at least one of a scale of the IP application, interoperability of the IP application, and a label of the IP application.
